(19) United States
(12) Patent Application Publication
(10) Pub. No.: US 2015/0233405 A1
(43) Pub. Date: Aug. 20, 2015

(54) CONNECTOR

(71) Applicants: Neill Jonathan BOSCH, Bonogin, Queensland (AU); Simon William BIRD, Bonogin, Queensland (AU)

(72) Inventors: Neill Jonathan Bosch, Bonogin (AU); Simon William Bird, Bonogin (AU)

(21) Appl. No.: 14/409,313

(22) PCT Filed: Jun. 13, 2013
(86) PCT No.: PCT/AU2013/000631

§ 371 Date: Dec. 18, 2014

(30) Foreign Application Priority Data
Jun. 13, 2012 (AU) 2012902987

(51) Int. Cl. F16B 12/14; F16B 12/04; A01G 1/08

(52) U.S. Cl. CPC F16B 12/14; A01G 1/08; F16B 12/04; F16B 2012/145

(57) ABSTRACT

A connector (100) for a modular garden bed is 100 described. The connector preferably includes a pair of wings members (101₁, 101₂) disposed at an angle to one another along a central seam (102). The wing members (101₁, 101₂) are contoured for complementary engagement with wall members (11) of the garden bed. A plurality of apertures (107) may be provided in the connector (100) for alignment with one or more corresponding apertures disposed within the wall members to permit the insertion of one or more fasteners to secure the connector (100) to the wall members (11).

### TECHNICAL FIELD

The present invention relates to an accessory for a garden bed assembly. In particular, but not exclusively, the present invention relates to an accessory for a garden bed assembly of the type assembled with corrugated sheeting.

### BACKGROUND ART

In recent years, it has become the practice of many property owners, particularly those in suburban areas, to grow their own vegetables. This has seen an increase in the use of raised garden beds. Such beds are particularly useful in areas of limited space such as in most suburban settings and in areas where the soil is of poor quality and/or where good drainage is required. However, building a raised garden bed can be a time-consuming and difficult affair. One of the reasons for this is that it is often necessary to assemble cumbersome elements, such as, rocks, building blocks and timber sleepers to define the volume in which the soil is to be retained.

As will be appreciated by those of skill in the art, the positioning of a garden bed is important to ensure optimum growing conditions for selected plant varieties. Given the nature of the construction of typical raised garden beds means that they are not readily transportable, either because of their size or weight and if positioned incorrectly it would be a difficult task to reposition the bed. In applications where there is limited space and a limited growing season, it is desirable to be able to remove the bed entirely. Again, given the nature of the construction of a typical raised bed means that it is often difficult to remove and store the bed away until it is next required.

Recently, the Applicants have conceived and developed a garden bed assembly of one or more sheets of corrugated material. In particular, the Applicants have used corrugated sheeting to assemble garden beds. The corrugated sheeting is generally of metal and can be of different gauges depending on the requirements. For example, the gauge can be that conventionally used for water tanks or that conventionally used for roofing.

Various versions of the modular garden bed assembly are discussed in Applicants' earlier co-pending applications, International patent application No PCT/AU2010/000703 entitled “A Modular Garden Bed”, Australian Provisional application No AU2011903383 entitled “A Modular Garden Bed” and Australian Innovation Patent No. 2009100623, the contents of each of which are herein incorporated by reference.

In modular garden bed assemblies of the Applicants' earlier applications, the joins between adjacent wall members are often coupled together via the use of connectors which is of a generally rectangular construction. In order to create the corner connection, the edge connectors are configured in pairs via the use of keyways disposed on each connector such that they define a substantially X-shaped construction. In this configuration, the corner connector will normally have a pair of inner arms (defined relative to the containing volume) to which the end edges of respective wall members can be attached and a pair of outer arms facing outwardly from the garden bed.

While the construction of the connectors of the applicants' earlier applications facilitates a good coupling between the wall members, the construction of the present connectors adds to the overall expense of the modular garden bed assembly as additional numbers of connectors are often required to facilitate corner connections. In addition as the X-shaped connector poses some safety risks, as the outer arms which extend outwardly from the garden bed, which can catch or snag on a users clothing or footwear which in the worst case scenario could throw the user off balance leading to fall. Consequently, the applicants have recognized that a need exists for alternatives to the present arrangement for interconnection of the wall members.

### SUMMARY OF INVENTION

Accordingly in one aspect of the present invention there is provided a connector for a modular garden bed, the connector including a body having a first portion and a second portion the first portion is disposed at an angle to the second portion; and wherein the first and second portions are contoured for complementary engagement with wall members of the garden bed.

The first and second portions may be in the form of wing members which are interconnected via a central seam. The first and second members are arranged such that they diverge from one another with respect to the central seam. Suitably the angle between the first portion and second portion is between 45° and 135°, 45° and 90°, 60° and 90°, 90° and 135°. Most preferably, the angular offset between the first and second portions is 90°.

Preferably, the contoured profile includes a series of ridges and furrows. The ridges and furrows may form a corrugated pattern. Suitably the corrugated pattern is a sinusoidal corrugated pattern but the pattern will typically depend upon the corrugations on the wall. The corrugated pattern may form one or more planar regions at discrete points in along the length of the central seam. In such instances, the shape of the planar regions is dependent upon the profile of the corrugate.

Further, each of the planar regions will define a fold between itself and each of the first and second portions. This fold will preferably provide an abutment surface, against which the ends of the respective wall members can abut to position each wall relative to the connector.

A plurality of apertures may be provided in the connector for alignment with one or more corresponding apertures disposed within the wall members to permit the insertion of one or more fasteners to secure the connector to the wall members. Suitably at least one aperture is provided in each of the furrows of the contoured profile.

The wall members will typically be substantially planar, although different shapes and configurations of wall members may allow the construction of modular garden beds of different shapes. Importantly, the wall member may be corrugated or have a different cross-section and still fall within the scope of the term “substantially planar”.

Each wall member will typically be generally rectangular. Preferably, each wall member will have an upper edge, an opposed lower edge and a pair of end edges. Normally, the end edges will be substantially vertical when the wall member is in use and the upper and lower edges will typically be substantially horizontal.

The wall members may be constructed of any material and a light metal or plastic will typically be preferred. The wall members may be rigid or flexible but it should be dimensionally stable in order to maintain their shape with little or no deflection even when the garden bed is constructive and contains what may be a substantial amount of soil or other plant growth media.

More than one wall member may be used to form a particular wall of the garden bed depending upon the length and/or height of the garden bed required. For example, each wall member may be configured as a single sheet or alternatively, a number of members may be required to form a wall.

The connector may be formed from a suitable metal such as steel. It will of course be appreciated by those of skill in the art that the connector could be formed from any suitable material such as Polyvinylchloride (PVC), HDPE, LDPE or other such suitable polymers.

In one preferred aspect, the present invention is directed to a connector for operatively joining together at least two panels, the panels each being corrugated, the connector comprising: an upper end, a lower end opposite the upper end, and a height from the lower end to the upper end; a first side from the lower end to the upper end, and a second side from the lower end to the upper end, each of the first and second sides having an edge, the edge of the first side and the edge of the second side each being non-linear along the height of the body, the first and second sides being at an angle relative to one another, each of the first and second sides including a means for attaching to one of the corrugated panels; and a central rib along the height from the lower end to the upper end, the central rib being generally linear along the height, the first side, the second side and the central rib forming a unitary structure.

In another preferred aspect, the present invention is directed to system for constructing a modular garden bed, the system comprising: at least two panels, each panel having a bottom, a top opposite the bottom, and a height, each panel having a generally undulating surface along the height; and a connector for operatively joining the panels, the connector having an upper end, a lower end, a height from the lower end to the upper end, a first side, and a second side, the first and second sides each having means for attaching the connector to one of the panels, each of the sides having a generally undulating surface configured to approximate the undulation of at least one of the panels the first side and the second side being at an angle relative to one another, the connector forming a unitary structure.

In one or more preferred embodiments, the connector may include a means for attaching the connector to one of the panels, the means including one or more apertures and one or more fasteners. The fastener may be a bolt. The central rib may include a plurality of bulbous portions along the height of the connector. Each bulbous portion may have a maximum dimension in a plane perpendicular to the height of the connector. The maximum dimension of each bulbous portion may be in the same plane as a ridge on each side. Each bulbous portion may include a generally planar interior surface. Each of the upper and lower ends of the connector includes an edge. The lower end of the connector preferably forms a foot to extend at least partially underneath one of the panels when the panel is attached to the connector. At least one of the sides of the connector is preferably configured to attach to an exterior surface of one of the panels. In another preferred embodiment, at least one of the sides of the connector is preferably configured to attach to an interior surface of one of the panels. The panels and connector preferably each have a maximum height of less than 1 m, more preferably less than 75 cm. At least one of the panels and/or connector preferably includes an anticorrosive coating.

The reference to any prior art in this specification is not, and should not be taken as an acknowledgement or any form of suggestion that the prior art forms part of the common general knowledge in Australia or in any other country.

### BRIEF DESCRIPTION OF DRAWINGS

In order that this invention may be more readily understood and put into practical effect, reference will now be made to the accompanying drawings, which illustrate preferred embodiments of the invention, and wherein:

FIG. 1 is a front view of a connector according to one embodiment of the present invention;

FIG. 2 is a side view of the connector of FIG. 1;

FIG. 3 is a rear view of the connector of FIG. 1;

FIG. 4 is a top plan view of the connector of FIG. 1;

FIG. 5 is a photo depicting the connector mounted in situ to form a corner between adjacent wall members according to one embodiment of the present invention;

FIG. 6 is a rear view of the connector in situ; and

FIG. 7 is a further view of the connector mounted in situ.

### DESCRIPTION OF EMBODIMENTS

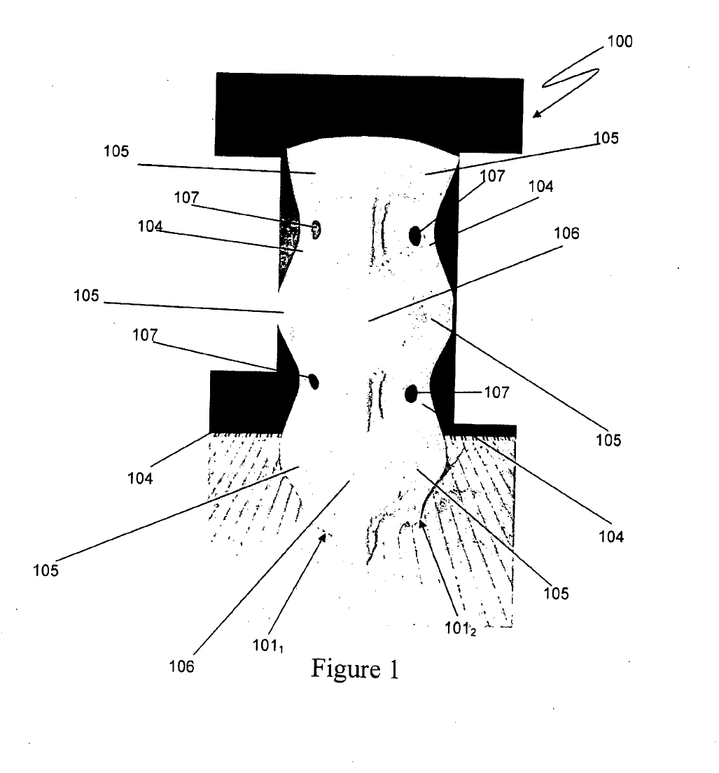

With reference to FIG. 1 there is illustrated a connector 100 according to one embodiment of the present invention. As shown the connector in this example is unitary construction. In this particular example the connector is formed from a suitable metal such as steel. It will of course be appreciated by those of skill in the art that the connector could be formed from any suitable material such as Polyvinylchloride (PVC), HDPE, LDPE or other such suitable polymers.

The connector 100 in this example includes a pair of wings 101₁, 101₂ disposed at an angle to one another along a central rib or seam 102. The central seam 102 when the connector 100 is mounted in situ foul's the apex of the angular joint between the wall members 11 of the garden bed which is discussed in greater detail below. As can be seen in this example, the wings 101₁, 101₂ are contoured to match the profile of the wall members 11 of the garden bed 10. The contour in this case is a sinusoidal corrugated pattern with a series of furrows 104 and ridges 105 formed along the length of each wing 101₁, 101₂. It will of course be appreciated by those of skill in the art that while in the present example a sinusoidal corrugated pattern is utilised that the wings contour to match other corrugated patterns or other surface profiles that may he provided on the wall members of the garden bed.

As can be seen in the depicted example, as the ridges 105 meet the central seam 102, a plurality of planar regions 106 are formed at discrete intervals along the length of the central seam 102. The planar regions in this case are substantially circular in shape given the sinusoidal pattern of the contour. In the present example, apertures 107 are disposed in each of the furrows 104, the apertures 107 co-operate with corresponding apertures disposed adjacent the ends of the wall members to which the connector 100 is to be attached to enable the insertion of a fastener such as a bolt or the like to secure the connector 100 and wall member together. The co-operation of the apertures 107 with the apertures on the wall member 11 assists the user with correct alignment of the wall member 11 and the connector 100.

It will of course be appreciated by those of skill in the art that in the apertures connector 100 and wall members 11 could be fastened together via other means. For example the connector could be fastened to the wall member by the use of a self tapping screw, rivet, etc.

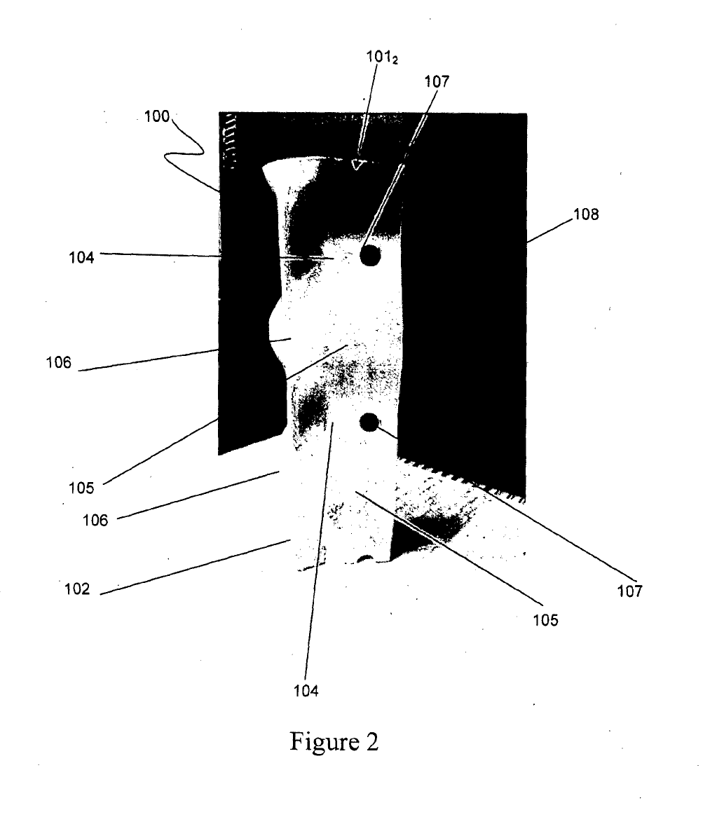

FIG. 2 is a side view of the connector 100 of FIG. 1 and shows the construction of the wings 101₁, 101₂ in further detail with only wing 101₂ fully visible. As shown, the apertures 107 in this case are positioned within the furrows 104 adjacent the exposed edge 108 of the wing. The amount of wall member retained behind the wing 101₂ in this case is determined by the positioning of the corresponding apertures disposed in the corresponding furrows of the wall member. That is, the positioning of the apertures from the vertical end of the wall member determines the depth of wall member retained behind the connector 100. As can be seen from FIG. 2, the section of the central seam 102 which extends across the furrows 104 remains substantially planar.

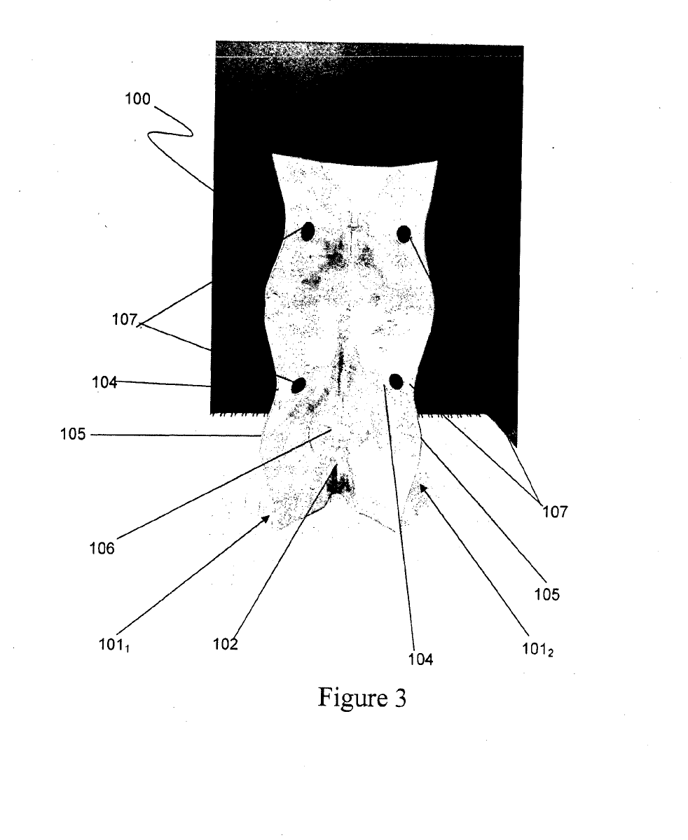

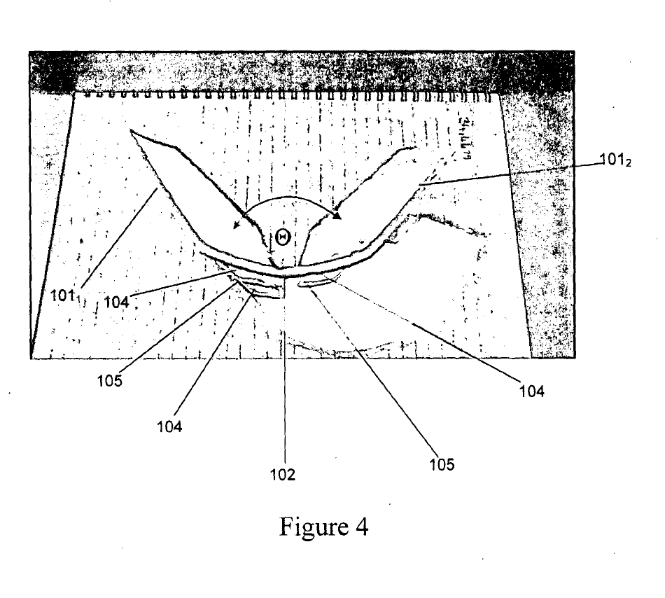

A rear view of the connector 100 is shown in FIG. 3. As can be seen, the rear face of each of the wings 101₁, 101₂ has a contoured pattern which mirrors that of the front face. Again, this view highlights the formation of the substantially circular planar regions 106 formed at the interface between ridges 105 and the rib 102. As shown in FIG. 4, the wings 101₁, 101₂ in this arrangement diverge with respect to the central seam 102 away from one another at an angle Θ.

The divergence between the wings can be more readily appreciated with reference to the top plan view shown in FIG. 4. As noted above, the wings 101₁, 101₂ diverge away from one another with respect to the central seam 102 such that the connector 100 has a generally V-shaped profile. As will be appreciated by those of skill in the art, the angle Θ between the wings 101₁, 101₂ defines the jointing angle between the wall members of the garden bed. In the present example, Θ is set to provide a right angled join of approximately 90°. The provision of a right join enables the connector 100 to be utilised for the provision of a square or rectangular garden bed.

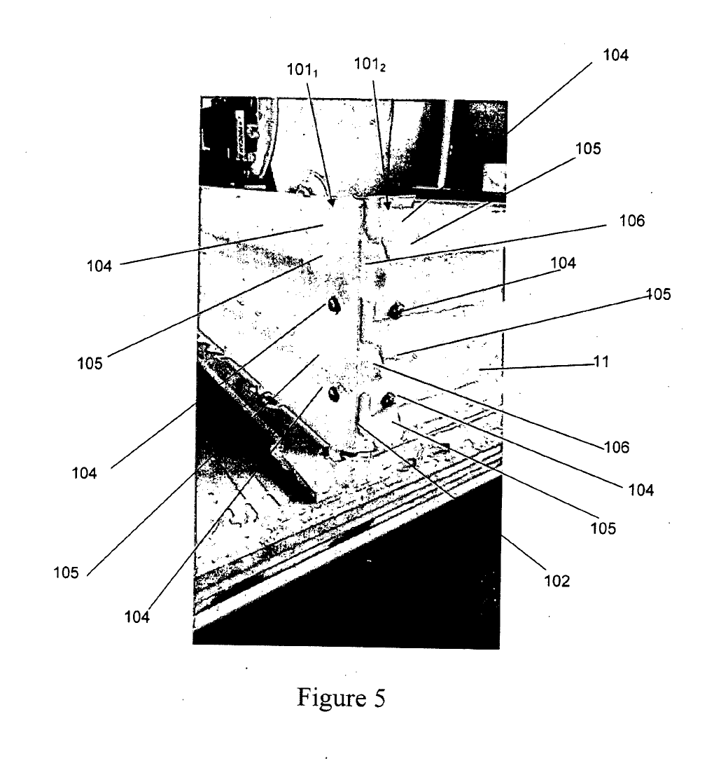

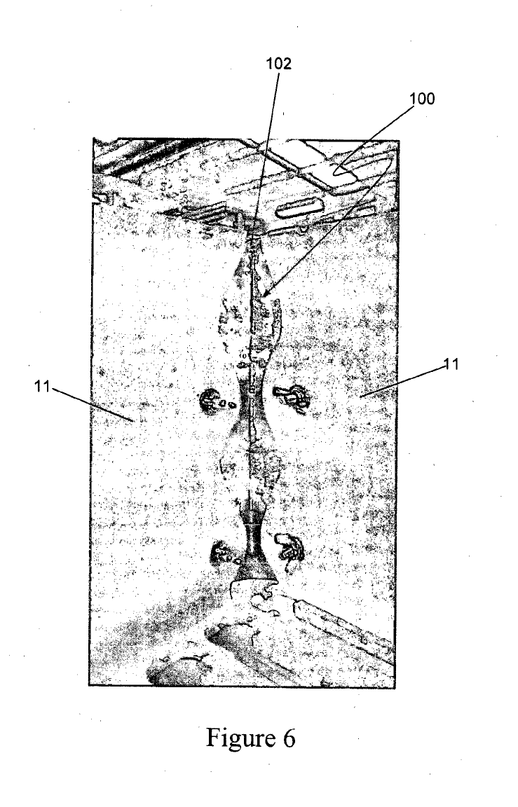

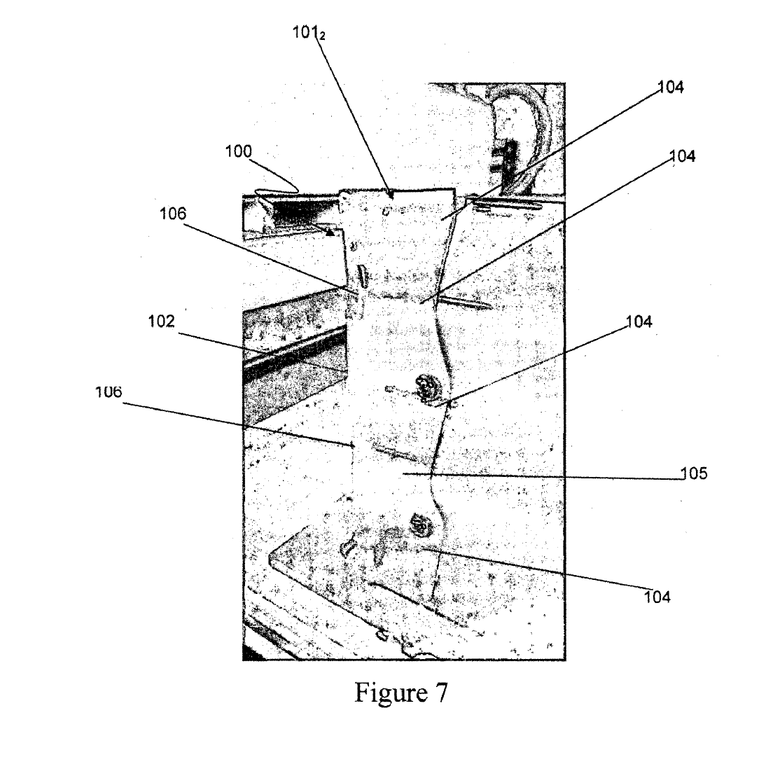

FIG. 5 depicts the connector 100 installed between adjacent wall members to form a right angled corner joint. As shown a section of each wall member 11 is retained behind the wings 101₁, 101₂ such that central seam 102 forms the vertex of the corner joint. To secure the join, bolts are inserted through the apertures 107 in the connector 100 and corresponding apertures within the wall members 11. Nuts are then attached and tightened to secure the connector 100 and wall members together; see FIG. 6. As the nuts are tightened, the ridges 105 and furrows 104 of the connector 100 are drawn against the corresponding ridges and furrows of the respective wall members 11; see FIG. 7. The overlapping relation with the ridges 105 and furrows 104 of the connector 100 with that of the wall provides a sufficiently tight join to guard against soil seepage through the join.

As can be seen in FIGS. 5 and 7, the lower end of the connector 100 can be rolled in to clamp the lower edge of the wall member to further enhance the strength of the join. The upper end of the connector may be retained against the upper edge of the wall members by the use of edging in the form of a rolled strip or as discussed in the applicants' earlier applications, an elongate cover member.

While the above discussed example has an angular displacement between the wings which is suitable for the formation of a right angle joint between the wall members 11, it will of course be appreciated by those of skill in the art that by varying the angle Θ, different jointing angles are possible. Varying the jointing angle also allows for the provision of alternate bed shapes. For instance, providing a connector with, an angular displacement of approximately 60° between the wings would enable 3 connectors to be utilised to form a triangular shaped bed. Other shapes that could be formed are octagons (Θ approx 135°), pentagons (Θ approx 108°), hexagons (Θ approx 120°), heptagons (Θ approx 128°, etc. In addition the jointing angle could be a reflex angle i.e. the angle reversed. The use of a reflex angle enables the production of a number of shaped beds such as T, L and Y shaped beds.

While the above discussion contemplates the formation of a suitable jointing angle by variation of the displacement between the wings by varying the angle Θ. It will of course be appreciated by those of skill in the art that it is possible to form the desired jointing angle by interconnecting two or more connectors. For example two 60° connectors could be joined together to a 120° connector. Similarly two 45° connectors could be joined together to a 90° connector. Additionally irregular angles can be formed by joining two or more connectors to form irregular shaped structures if required.

The above examples focus on the use of a connector to form a raised garden bed however the applicant has also realised that the connector can be utilised in the construction of other structures. For example the connector could be utilised as flashing or barge cap flash corners or edges of buildings. In such cases the connector could be run off in standard lengths of I 1.8 m, 2.4 m, 4 m, 6 m and 8 m. It will of course be appreciated by those of skill in the art that one or more connectors can be overlapped at adjacent ends to form a desired length of capping i.e. a 2.4 m length could be joined with a 1.8 m length to form a 4.2 m length of capping, etc.

It is to be understood that the above embodiments have been provided only by way of exemplification of this invention, and that further modifications and improvements thereto, as would be apparent to persons skilled in the relevant art, are deemed to fall within the broad scope and ambit of the present invention described herein.

1. A connector for operatively joining together at least two panels, the panels each being corrugated, the connector comprising:
an upper end, a lower end opposite said upper end, and a height from said lower end to said upper end;
a first side from said lower end to said upper end, and a second side from said lower end to said upper end, each of said first and second sides having an edge, said edge of said first side and said edge of said second side each including a plurality of grooves oriented perpendicular to the height of the connector along the height of said body, a trough of each groove on said first side being coplanar along a horizontal plane with a corresponding trough on said second side, said first and second sides being at an angle relative to one another, each of said first and second sides including a means for attaching to one of the corrugated panels; and
a central rib along the height from said lower end to said upper end, said central rib being generally linear along the height, said first side, said second side and said central rib forming a unitary structure.

2. The connector of claim 1, wherein said means for attaching includes a plurality of apertures, each aperture being configured to receive a fastener for fastening said connector to one of the panels.

3. The connector of claim 2, wherein each of said apertures is positioned in one of said grooves.

4. The connector of any one of the above claims 1, wherein said central rib includes a plurality of bulbous portions along the height of the connector.

5. The connector of claim 4, wherein each side includes a plurality of ridges oriented perpendicular to the height of the connector, each bulbous portion having a maximum dimension in the same plane as one of said ridges.

6. The connector of claim 4, wherein each bulbous portion includes a generally planar interior surface.

7. The connector of claim 1, wherein each of said upper and lower ends includes an edge, said edge of said lower end being offset relative to said edge of said upper end.

8. The connector of claim 1, wherein said lower end is formed as a foot to extend at least partially underneath one of the panels when the panel is attached to the connector.

9. The connector of claim 1, wherein at least one of said sides is configured to attach to an exterior surface of one of the panels.

10. The connector of the above claim 1, wherein at least one of said sides is configured to attach to an interior surface of one of the panels.

11. (canceled)

12. (canceled)

13. The connector of claim 1, wherein said first side is disposed at an angle between 45° and 90° from said second side.

14. The connector of claim 1, wherein said first side is disposed at an angle between 45° and 135° from said second side.

15. The connector of claim 1, wherein said first side is disposed at an angle between 60° and 90° from said second side.

16. The connector of claim 1, wherein said first side is disposed at an angle between 90° and 135° from said second side.

17. The connector of claim 1, wherein the angle between said first and second sides is 90°.

18. (canceled)

19. A system for constructing a modular garden bed, the system comprising:
at least two panels, each panel having a bottom, a top opposite said bottom, and a height, each panel having a generally undulating surface along the height; and
a connector for operatively joining said panels, said connector having an upper end, a lower end, a height from said lower end to said upper end, a first side, and a second side, said first and second sides each having means for attaching said connector to one of said panels, each of said sides having a generally undulating surface configured to approximate the undulation of at least one of said panels, said undulating surface of each of said sides including a plurality of grooves, a trough of each groove on said first side being coplanar along a horizontal plane with a corresponding trough on said second side, said first side and said second side being at an angle relative to one another, said connector forming a unitary structure.

20. The system of claim 19, wherein the height of said connector is generally equal to the height of each panel.

21. The system of claim 19, wherein said undulating surface of each side of said connector extends along the entire height of said connector.

22. The system of claim 19, wherein said means for attaching includes a plurality of apertures.

23. The system of claim 19, wherein said means for attaching includes a fastener.

24. The system of claim 23, wherein said fastener is a bolt.

25. (canceled)

26. (canceled)

27. The system of claim 19, wherein said first side is disposed at an angle between 45° and 90° from said second side.

28. The system of claim 19, wherein said first side is disposed at an angle between 45° and 135° from said second side.

29. The system of claim 19, wherein said first side is disposed at an angle between 60° and 90° from said second side.

30. The system of claim 19, wherein said first side is disposed at an angle between 90° and 135° from said second side.

31. The system of claim 19, wherein the angle between said first and second sides is 90°.

32. (canceled)
